(19) United States
(12) Patent Application Publication
(10) Pub. No.: US 2004/0018137 A1
(43) Pub. Date: Jan. 29, 2004

(54) Boron doped blue diamond and its production

(75) Inventor: Yue Meng, Naperville, IL (US)

Correspondence Address: General Electric Company, One Plastics Avenue, Pittsfield, MA, 01201, US

(73) Assignee: GENERAL ELECTRIC COMPANY

(21) Appl. No.: 10/262,784

(22) Filed: Oct. 2, 2002

Related U.S. Application Data
(63) Continuation-in-part of application No. 09/935,957, filed on Aug. 23, 2001.

(51) Int. Cl. C01B 31/06

(52) U.S. Cl. 423/446

(57) ABSTRACT

A method for synthesizing boron doped diamond for improving the oxidation resistance of said diamond crystals includes forming a fully dense core (mixture) of graphite, catalyst/solvent metals, optional diamond seed crystals, and a source of boron. This mixture is subjected to diamond-formed high pressure/high temperature (HP/HT) conditions for a time adequate for forming diamond. The thus-formed diamond product is recovered to contain boron substituted into the diamond structure. The fully dense core is substantially devoid of air/nitrogen (N) content. In one embodiment, the boron amorphous B.

### CROSS-REFERENCE TO RELATED APPLICATIONS

This Application claims rights of priority from U.S. patent application Ser. No. 09/935,957, filed Aug. 23, 2001, which is hereby incorporated by reference.

### BACKGROUND OF THE INVENTION

The present invention relates generally to diamond particles and more particularly to increasing their compressive fracture strength and improving their oxidation resistance by substituting boron (B) into the diamond crystal.

Its hardness and thermal properties are but two of the characteristics that make diamond useful in a variety of industrial components. Initially, natural diamond was used in a variety of abrasive applications. With the ability to synthesize diamond by high pressure/high temperature (HP/HT) techniques utilizing a solvent/catalyst aid under conditions where diamond is the thermodynamically stable form of carbon phase, a variety of additional products found favor in the marketplace. Typically, the HP/HT conditions used in the solvent/catalyst synthesizing method includes a temperature in the range of about 1300° to 2000° C. and a pressure in the range of about 5 to 10 GPa. Polycrystalline diamond compacts, often supported on a WC support in cylindrical or annular form, extended the product line for diamond. However, the requirement of high pressure and high temperature has been a limitation in product configuration, for example. Of more recent vintage, is the low-pressure growth of diamond, dubbed “chemical vapor deposition” or “CVD”. Additional product configuration is permitted by this diamond growth technique.

Regardless of whether the diamond is natural or synthetic, and regardless of the manner in which the synthetic diamond has been grown, diamond suffers from being unstable at elevated temperature. As the art is well aware, processing of diamond at temperatures of above 600° to 700° C. requires an inert atmosphere; otherwise, the diamond will oxidize. Thus, the ability to increase the oxidation resistance of diamond would be welcome in the art. For example, the life of diamond tools would be prolonged due to the resistance of diamond to oxidation during tool applications, and in addition, processing of diamond into various tools and workpieces at increased temperatures would be permitted.

Another valuable property of diamond is its compressive fracture strength. Compressive fracture strength measures the mechanical strength of a diamond crystal and is the static force required to break (or fracture) the crystal. Compressive fracture strength is a quantifiable mechanical property of diamond grit. Typically, hundreds of grit are tested and the average force recorded to break the grit is used as the compressive fracture strength of that particular grit product. Heretofore, etching of diamond grit for one hour in molten potassium nitrate at 870° K was reported to increase the strength of the diamond grit due to the removal of surface roughness and defects (See pp. 489-490, The Properties of Natural and Synthetic Diamond, Ed. by J. E. Field, 1992).

An indication that boron has been incorporated into the lattice of the diamond structure is by its color. Diamond is blue in color with the addition of boron. Boron doped “blue” diamond, which has been disclosed in the art (see EP 0 892 092 A1; and U.S. Pat. Nos. 2,992,900; 3,141,855; 3,148,161; 3,268,457; 3,303,053; 3,310,501; 4,042,673; 4,082,185; 4,301,134; 4,082,185; 6,030,595, JP 05200271, and WO8304016) has been synthesized with changed optical and electrical properties. Boron doped diamond is considered to have improved oxidation resistance (See Properties and Applications of Diamond, Wilks, John, et.al., ISBN 0-7506-1067-0, 1991, page 364). WO8304016, U.S. Pat. No. 3,141,855 and U.S. Pat. No. 3,268,475 teach the doping of surface layers of a diamond crystal with boron via diffusion processes.

U.S. Pat. Nos. 4,042,673, 4,082,185, 4,301,134, 6,030,595, and JP05200271 teach the synthesis of boron-doped diamond via the temperature gradient method. However, the temperature gradient method for producing such boron doped diamond is not an economic method for producing diamond for sawing and grinding purposes, though it may be for gemstone quality diamond.

U.S. Pat. Nos. 2,992,900, 3,148,161, 3,303,053, and 3,310,501 disclose boron-dope diamond by the layered reaction cell method, with U.S. Pat. No. 3,310,501 specifically demonstrating that non-uniform distribution of boron is desired. Layered cells use alternating discrete catalyst metal and carbon or graphite components in such as disks, rods, cylinders, or foils to homogenize the reaction mass. Diamond nuclei may or may not be included in the reaction mass. Boron doping is accomplished by applying boron compounds to the surfaces of the catalyst or carbon or graphite components. This design is suitable for high volume production, but the gross chemical heterogeneities from the layer structure do not support, uniform, three dimensional growth of diamond crystals. The yield of high quality crystals is not high.

Improved diamond quality has been demonstrated from the intimate mixing of catalyst, carbon and diamond nuclei (see Chien-Min J Sung, Optimized cell design for high-pressure synthesis of diamond, High Temperatures—High Pressures—2001, vol 33, p489-501).

There still exists a need in the art to produce high quality crystals boron doped diamond in an economical manner for industrial use in grinding, sawing, and other similar applications. Applicants have developed a powder cell method to grow boron doped diamond crystals. This is the first time that high quality boron-doped diamond crystals are produced using a powder cell apparatus.

### BRIEF SUMMARY OF THE INVENTION

A method for producing boron doped diamond for grinding, sawing and other machining applications includes forming a uniform mixture of graphite, catalyst/solvent sintering aid, a source of boron, and optionally, diamond seed crystals to produce fully dense core substantially devoid of nitrogen and oxygen (N and O), and subjecting the dense core to high pressure/high temperature (HP/HT) conditions for a sufficient amount of time for forming diamond having boron substituted throughout the diamond crystal structure.

In one embodiment, amorphous boron is used to to form the boron-doped, blue diamond of the present invention.

### BRIEF DESCRIPTION OF THE DRAWINGS

FIG. 1 is the graphical plot of the thermogravimetric analysis results of samples of an undoped diamond; and

FIG. 2 is the graphical plot of the thermogravimetric analysis results of samples of boron doped diamond.

The drawings will be described in detail in the Examples.

### DETAILED DESCRIPTION OF THE INVENTION

Boron is one of only two elements (nitrogen being the other) that can substitute for the carbon atom in the diamond structure. Boron's substitution in diamond structure enables the boron-doped diamond to exhibit improved mechanical strength and oxidation resistance.

The present invention employs a powder cell apparatus to produce boron-doped diamonds. In a powder cell method, the reactants, e.g., graphite/catalyst/nuclei, etc., are mixed as powders and consolidated into a solid core. The powder cell approach is different from the other methods of the prior art in that, in a layered cell method, the reactants are discrete components in the layered cell (a disk of metal catalyst, a disk of graphite, etc.); and in the thermal gradient cell, the reactants are also discrete components and a heating gradient is required.

As the data will demonstrate, the boron doped diamond crystals of the present invention exhibit improved oxidation resistance. That is, the boron-doped diamond crystals can tolerate higher temperature than regular industrial diamond. This means that tool manufacturing can process tool making at a higher temperature which can be advantageous to tool manufacturers. Moreover, this also means that the ultimate tools also can be used in tasks that heretofore were foreclosed to diamond because of the expected temperatures that would be encountered in the field. Such advantages should not be limited to any particular tools. That is, the boron-diffused diamond should have advantage in wire drawing dies, resin bond tools, metal bond tools, saw blades, compacts, and the like.

The initial step of the process commences with formation of a uniform mixture of catalyst metal, boron and graphite. Diamond seed crystals can be used as is well known in the art. The amount of boron will range from about 0.1 to about 0.5 weight-% of the total core composition with about 0.15 wt-% presently preferred. Sources of boron include, inter alia, B₄C in a range of from about 0.1 to about 0.5 wt-% with 0.25 wt-% being preferred; Fe-B alloy in a range to provide a B content of from about 0.1 to about 0.5 wt-%; metallic boron and amorphous B powder in a range of from about 0.1 to about 0.5 wt-% with about 0.15 wt-% being preferred. The presently preferred source of B is amorphous B having a particle size from about 5 μm to −80 mesh in size. Again, the lower limit is more dictated by handling considerations, especially at commercial scale operations.

In order to exclude N,O or other contaminants attributable to air, from being present in the core, the mixture is pressed to be nominally fully dense. Being fully dense, for present purposes, means that the pressed core is substantially devoid of any trapped gasses, notably air, as a measure of N content. The presence of N prevents the incorporation of B into the diamond structure, resulting in B being present as an impurity inclusion and consenquently diamond crystals of black color. The novel boron doped, blue diamond has less B as an impurity inclusion than that of black color diamond.

In one embodiment, the gaseous contaminant may be excluded by other, well known methods: the use of scavenging “getter” constituents, evacuation, and substitution by other gasses that do not affect the development of the diamond crystal. As used herein the term “scavenger” or “scavenging getter” refers to a material that is added to a mixture to remove or inactivate unwanted materials such as entrapped N, O, or other contaminants. In one embodiment, a scavenging getter, e.g., a scavenger metal functions to scavenge at least a portion of any oxygen that is present in the mixture. Scavenging of oxygen occurs by an oxidation process wherein the oxygen scavenger metal reacts with at least some of the oxygen that is present during the fusing of the dense core. This reaction results in the oxygen scavenger metal being converted into an oxide. By way of example, aluminum (Al) may act as an oxygen scavenger metal by reacting with oxygen (O₂) to form aluminum oxide (Al₂O₃).

The core, then, is subjected to conventional HP/HT processing at a sufficient temperature and for a sufficient amount of time in a conventional high pressure/high temperature (HP/HT) apparatuses, which may be of the belt-type or die-type, are described, for example, in U.S. Pat. Nos. 2,941,241; 2,941,248; 2,947,617; 3,609,818; 3,767,371; 4,289,503; 4,409,193; 4,673,414; 4,810,479; and 4,954,139, and French Pat. No. 2,597,087. In one embodiment, the temperatures range from about 1300° to about 2000° C. with corresponding pressures ranging from about 5 to about 10 GPa. In another embodiment, the time ranges from about 30 seconds up to as long as 3 hours. In yet another embodiment, from around 5 minutes up to 2 hours.

The boron-doped diamond product, then, is recovered from the apparatus in conventional fashion by first lowering the temperature and then the pressure. Conventional finishing operations (e.g., grinding, acid washing, etc.) are used to recover the product, which then can be used in a variety of sawing, grinding, and other industrial applications.

While the invention has been described with reference to a preferred embodiment, those skilled in the art will understand that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In this application all units are in the metric system and all amounts and percentages are by weight, unless otherwise expressly indicated. Also, all citations referred herein are expressly incorporated herein by reference.

Thermogravimetric analysis (TGA) is a continuous measurement of sample weight under elevated temperature conditions in a static “air” atmosphere. A decrease in sample weight is indicative of volatile reaction products being evolved from the sample. For diamond, oxygen will react at elevated temperature to form CO, CO₂, and mixtures thereof. J. E. Field (Editor), The Properties of Diamond, Academic Press, New York, N.Y. (1979). The boron-doped diamond of the present invention has demonstrated significant improved oxidation resistance compared to a similar diamond that is undoped (untreated), characterized as having a weight loss of less than one third (⅓) of an undoped diamond, as measured by thermogravimetric analysis (TGA).

In one embodiment of the invention, the boron-doped diamond crystal of the invention is characterized as having a weight loss rate of less than 0.25% per minute at 850° C. in air. In another embodiment, it is characterized as having a weight loss in air beginning at a temperature of 700° C. or higher.

### EXAMPLES

TGA curves reported in the Examples were generated on a 951 Thermogravimetric Analyzer by DuPont Instruments with all samples being placed on a platinum sample holder. The temperature was increased at a rate of 10° C./min.

Cores made from graphite and catalyst/solvent metals (sintering aid) with 0.15 wt-% amorphous B were pressed to a fully dense state. The cores then were subjected to conventional HP/HT processing. A recovered fraction, 140/170 mesh, having a Toughness Index (TI) of 47 was chosen for testing along with an undoped reference diamond fraction having the same mesh size and a TI of 46.

Toughness index (“TI”) is measured by placing 2 carats of material in a capsule with a steel ball, agitating it vigorously for a fixed amount of time, and measuring the weight of fragments produced of a certain size with respect to a certain starting weight of a certain size. The size of the steel ball employed and the agitating time vary with the size of the diamond abrasive grains. In one example, a certain amount of material which has passed a 139 μm-mesh screen and was retained on a 107 μm-mesh screen, corresponding the size 120/140, is put together with a steel ball of 7.94 mm in diameter in a 2 ml-capsule, set on a vibration tester, and subjected to milling for a certain time period (30.0±0.3 seconds), followed by screening with a 90 μm-mesh screen. The amount of the crystals remained on the 90 μm-mesh screen is expressed as a weight percent based on the starting crystals.

Thermogravimetric analysis was performed under the following test conditions:

Static air

Samples heated to 850° C. at a rate of 50° C./min

Samples then held at 850° C. for 1 hour

The weight of the samples was monitored and the rate of weight change at 850° C. during the first 8 minutes at temperature was recorded. The presence of air results in oxidation of the diamond.

The following results were recorded:

Rate of weight change of reference diamond: −0.83% per minute

Rate of weight change of B-doped diamond: −0.21% per minute

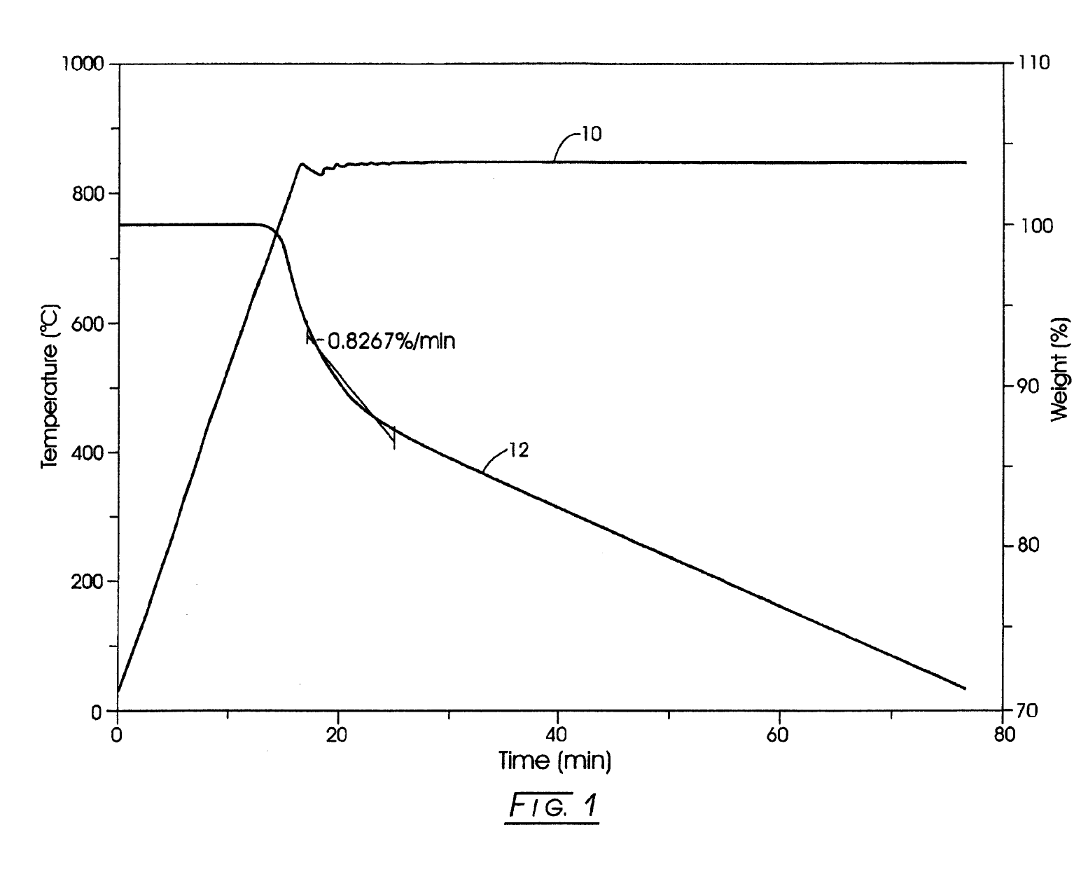

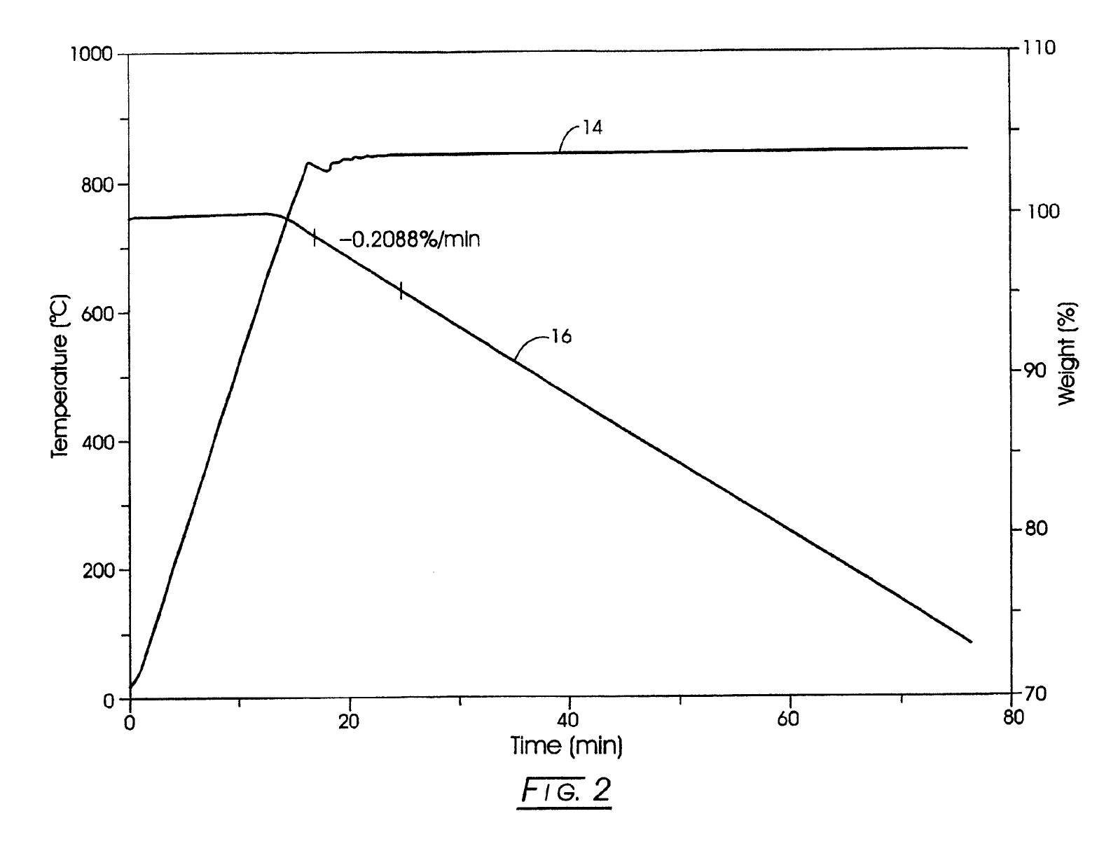

FIG. 1 graphiclly depicts the TGA test results for the comparative sample. Line 10 displays the temperature of heating of the samples, while line 12 represents the amount (wt-%) of the sample. FIG. 2 graphiclly depicts the TGA test results for the inventive, B-doped sample. Line 14 displays the temperature of heating of the samples, while line 16 represents the amount (wt-%) of the sample. These TGA test results reveal the enhanced oxidation resistance of the boron doped diamonds produced by the powder cell method of the present invention. The rate of weight loss for the inventive B diffused samples was only about one-fourth that of the comparative samples.

1. A method for synthesizing boron-doped diamond for improving the oxidation resistance, which comprises:
(a) pressing a mixture of non-diamond carbon powder, at least one of a catalyst or solvent metal powders, and a source of boron to form a dense core;
(b) subjecting said dense core to diamond forming high pressure/high temperature (HP/HT) conditions for a time adequate for forming diamond having boron substituted into the diamond structure; and
(d) recovering said boron diamond product.

2. The process of claim 1, wherein said mixture of non-diamond carbon powder, at least one of a catalyst or solvent metal powders, and a source of boron is compressed at a sufficient pressure to form a dense core substantially devoid of entrapped gases.

3. The process of claim 1, wherein said mixture further comprises at least one of a scavenging getter constituent for substantially removing entrapped gases in said dense core.

4. The method of claim 1, wherein said mixture further comprises diamond seed crystals.

3. The method of claim 1, wherein the amount of boron in said core ranges from about 0.1 to about 0.5 weight-% of the total core.

4. The method of claim 1, wherein said boron is selected from B₄C, an FeB alloy, metallic boron, and amorphous B powder.

5. The method of claim 4, wherein said boron is present from about 0.1 to about 0.5 wt %.

6. The method of claim 4, wherein said boron is an amorphous boron powder having a size ranging from between about 5 μm to about 45/50 mesh.

7. The method of claim 1, wherein said HP/HT conditions include a temperature ranging from about 1300° to about 2000° C. with corresponding pressures ranging from about 5 to about 10 Gpa.

8. A boron doped diamond made by the process of claim 1.

9. An article comprising the boron-doped diamond of claim 8.

10. The article of claim 9, in the form of a compact, a wire drawing die, a resin bood tool, a metal bond tool, or a saw blade.

11. A boron-doped diamond crystal, wherein the dopant boron concentration is uniformly distributed within said diamond crystal, and wherein said diamond crystal is produced in a power cell apparatus at a sufficient high pressure/high temperature (HP/HT) conditions and for a time adequate for said dopant boron to be substituted into the diamond crystal structure.

12. The boron-doped diamond crystal of claim 11, wherein said dopant boron is present in an amount of about about 0.1 to about 0.5 wt %.

13. The boron-doped diamond crytal of claim 11, wherein said dopant boron is selected from B₄C, an FeB alloy, metallic boron, and amorphous B powder.

14. The boron-doped diamond crystal of claim 13, wherein said dopant boron is an amorphous boron powder having a size ranging from between about 5 μm to about 45/50 mesh.

15. An article comprising the boron-doped diamond of claim 11.

16. The article of claim 16, in the form of a compact, a wire drawing die, a resin bood tool, a metal bond tool, or a saw blade.

17. A boron-doped diamond characterized by having a weight loss of less than one third of the weight loss of a similar diamond free from said boron dopant.

18. The boron-doped diamond of claim 17, further characterized as having a uniformly distributed boron dopant within said diamond and wherein said boron dopant is selected from B₄C, an FeB alloy, metallic boron, and amorphous B powder.

19. A boron-doped diamond crystal characterized as having a weight loss rate of less than 0.25% per minute at 850° C. in air.

20. The boron-doped diamond crystal of claim 18, further characterized as having a weight loss in air beginning at a temperature of 700° C. or higher.
